(19) United States
(12) Patent Application Publication
(10) Pub. No.: US 2018/0188402 A1
(43) Pub. Date: Jul. 5, 2018

(54) A COMPUTER-IMPLEMENTED METHOD AND A SYSTEM FOR PROCESSING ACOUSTIC SIGNALS

(71) Applicant: SCHLUMBERGER TECHNOLOGY CORPORATION, Sugar Land, TX (US)

(72) Inventors: Timur Vyacheslavovich ZHARNIKOV, Moscow (RU); German Sergeevich SCHELIK, Dolgoprudny (RU); Takeshi ENDO, Sagamihara (JP); Denis Evgenievich SYRESIN, Sagamihara (JP); Toshihiro KINOSHITA, Sagamihara-shi (JP)

(73) Assignee: SCHLUMBERGER TECHNOLOGY CORPORATION, Sugar Land, TX (US)

(21) Appl. No.: 15/738,659

(22) PCT Filed: Jun. 22, 2015
(86) PCT No.: PCT/RU2015/000381

§ 371 Date: Dec. 21, 2017

(51) Int. Cl. G01V 1/48; G01V 1/36

(52) U.S. Cl. CPC G01V 1/48; G01V 2210/324; G01V 1/364

(57) ABSTRACT

Acoustic signals sent by a logging tool disposed in a borehole are detected by receivers located on the logging tool. Time domain representations of the detected acoustic signals are converted into frequency domain representations. Then at least one frequency range is selected and the detected acoustic signals corresponding to each selected frequency range are filtered. Eigenvectors for the filtered data for each selected frequency range are computed and dependence of the eigenvectors on the frequency is obtained. System for processing acoustic signals comprises a computer in communication with the logging tool and a set of instructions executable by the computer.

### FIELD OF THE INVENTION

The disclosure relates to acoustic well logging, namely to a signal processing technique.

### BACKGROUND OF THE INVENTION

In acoustic logging, a tool is lowered into a borehole and acoustic energy is transmitted from a source into the borehole and the formation. The acoustic waves that travel in the formation are then detected with an array of receivers. The receivers detect the acoustic energy as it propagates along the borehole wall and in the formation, the receivers creating a plurality of time domain signals.

Important application of acoustic logging is the determination of the anisotropy, including estimation of the anisotropy direction and anisotropy intensity. It is an important part of anisotropy processing and is an integral part of a number of workflows in geomechanics, fracture characterization, etc. It also bears on the correct computation of the dispersion curves using matrix-pencil algorithm. The popular method for the anisotropy direction estimation from the results of cross-dipole sonic logging is Alford rotation (see, for example, R. M. Alford, Shear Data in the presence of azimuthal anisotropy, Dilley, Tex., SEG Technical Program Expanded Abstracts, 1986, pp. 476-479).

Alford rotation is known to be correct and robust method for the anisotropy estimation. The drawback of this approach is that it is relevant when the two flexural modes are geometrically orthogonal, their orientation does not vary with the frequency, and they are non-dispersive. In more complex situations, which are encountered, for example, when the measurement setup does not possess the symmetry, it fails and can give inaccurate results. Such situations include but are not limited to the stress-induced anisotropy in anisotropic formations, eccentered tool in anisotropic formations, non-circular boreholes in anisotropic formations, etc. It is known that in the absence of the symmetry the orientations of the two flexural modes may not be orthogonal and start depending on the frequency.

The disclosed method allows the computation of the orientation of the flexural modes in the general case with proper account for their possible geometrical non-orthogonality, asymmetry, and the frequency dependence of their orientation.

### SUMMARY

According to the disclosed method acoustic signals are sent by a logging tool disposed in a borehole traversing a subterranean formation. The acoustic signals as they traverse the subterranean formation are detected by receivers located on the logging tool. Time domain representations of the detected acoustic signals are created. The time domain representations of the detected acoustic signals are converted into frequency domain representations. Then at least one frequency range is selected and the detected acoustic signals corresponding to each selected frequency range are filtered. Eigenvectors for the filtered data for each selected frequency range are computed and dependence of the eigenvectors on the frequency is obtained.

System for processing acoustic signals comprises a logging tool for sending acoustic signals in a borehole and receivers located on the logging tool for detecting the acoustic signals as they traverse the subterranean formation. The system also comprises a computer in communication with the logging tool and a set of instructions executable by the computer that, when executed by the computer cause the computer to create time domain representations of the detected acoustic signals, to convert the time domain representations of the detected acoustic signals into frequency domain representations, to select at least one frequency range, to filter the detected acoustic signals corresponding to each selected frequency range, and to compute eigenvectors for the filtered data for each selected frequency range and obtain dependence of the eigenvectors on the frequency.

### BRIEF DESCRIPTION OF THE DRAWINGS

FIG. 1 is a schematic description of a wireline-logging system with an acoustical logging tool disposed in borehole and controlling and processing means outside.

### DETAILED DESCRIPTION

The main idea of the invention is to identify eigenvectors at each frequency.

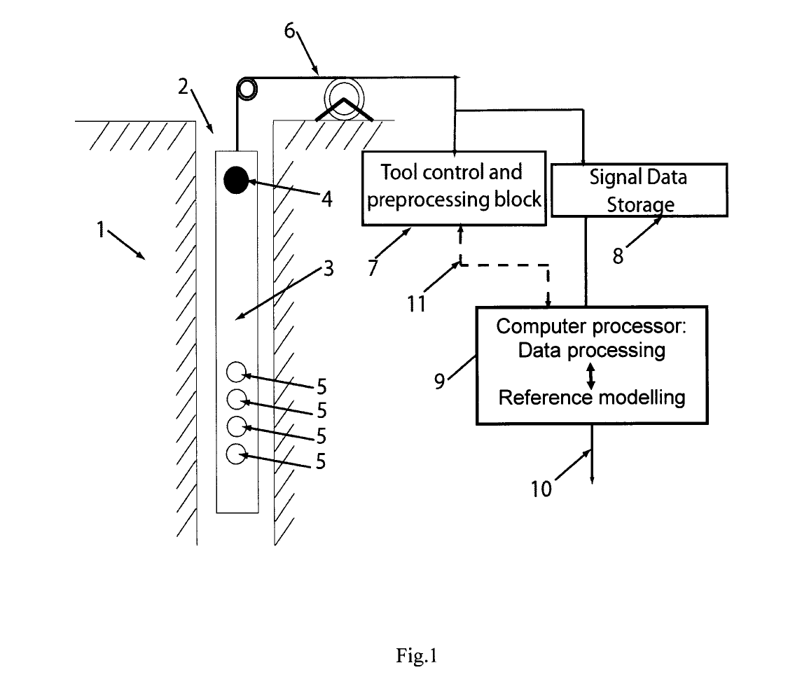

FIG. 1 shows the general illustration of the measurement by a logging tool in a borehole and processing outside it. To study physical properties of a subterranean formation 1 a borehole 2 traversing the formation 1 is drilled. The formation may be inhomogeneous and anisotropic, while the borehole can have a noncircular shape of cross section. In acoustic logging, a tool 3 is lowered into the borehole and acoustic energy is transmitted from transducers 4 into the borehole and the formation. The acoustic waves that travel in the formation are then detected with an array of receivers 5. To push or pull the tool inside the formation 1 and to control its depth a logging/data cable 6 is often used. Through this cable the information about the acoustic signals, measured by the array of receivers 5 can be acquired. This data may flow to a tool control block 7 or to a data storage 8 device. The main goal of the block 7 is to control the tool and environment in the borehole 2 (e.g. tool depth). This block 7 may be also used for data preprocessing in order to control the data quality and to adjust some logging parameters (e.g. speed of movement, frequency band, etc.). The data storage device 8 records and keeps the data about the measured signals and logging conditions. This data goes to and is processed by a computer processor 9. The computer processor 9 makes full or partial processing of the input data, applies the filters if necessary, and provides the calculation of waveforms, dispersion curves and signal spectra, eigenvectors and rotation angles, according to the input data. The reference dispersion curves, waveforms and spectra, eigenvectors and rotation angles are modelled inside the computer processor 9, as well. Using the procedure explained in detail below the input and generated reference data are compared iteratively inside this processor 9. As a result at least a portion of the set of elastic or geometrical borehole-formation parameters is outputted through a channel 10. According to the difference between measured and reference data the decision about adjusting the logging conditions may be formulated inside the computer processor 9 and delivered to the control block 7 through a feedback channel 11.

Acoustic data acquired with the logging tool 3 are waveforms received by the receivers. These waveforms include a large amount of data, which would need to be analyzed with an appropriate method to derive information related to formation properties.

The acoustic data taken by the logging tool 3 and received by the computer processor 9 (in-situ or at the surface) may be processed according to instructions accessible to the computer processor 9 to perform the processing described below.

For example, the signals can be recorded as waveforms (the dependence of pressure on time). These waveforms are represented as arrays, which are stored in computer memory. The processing software takes these arrays and manipulates them. For example, using the semblance processing of these arrays (Christopher V. Kimball, Thomas L. Marzetta, Semblance processing of borehole acoustic array data, GEOPHYSICS March 1984, Vol. 49, No. 3, pp. 274-281), implemented as a computer program, one can estimate the velocity of the various waves propagating in borehole.

Time domain representations of the detected acoustic signals are created.

Then, frequency data representations in the frequency domain are obtained. For example, the time domain representations of the acoustic signals can be converted into the frequency domain representations by Fourier transforming, by frequency filtering or by wavelet transforming.

At least one frequency range is selected. The exact number of ranges and the choice of frequencies for each range depends on various factors, such as the measurement conditions, type of rock, borehole size, etc. For example, one can process the data as it is—in this case there will be one frequency range covering all of the frequencies. If only low frequency response is of interest, then one can decide to choose one frequency range, but make it from zero frequency up to some specific frequency fᵤ. If most of the signal energy falls into the frequency range from f_{b} to fᵤ and it is expected that behavior of the signal for low, mid, and high frequencies markedly differs, one can choose three ranges—(f_{b},f₁), (f₁,f₂), (f₂,fᵤ)—which are representative of the frequency ranges of interest.

The detected acoustic signals corresponding to each selected frequency range are filtered by standard algorithms (including but not limited to time domain Fourier transform, frequency filtering, wavelet transform, etc.). For example, start with the Fourier transform f(ω,zᵢ,θⱼ) of the waveform f(t,zᵢ,θⱼ). The latter is the dependence of pressure on time for the receiver (typically hydrophone), located at the depth zᵢ and the azimuth θⱼ. Then, to filter the signal, one can take, for example, the value f(ωₖ,zᵢ,θⱼ) of the transform f(ω,zᵢ,θⱼ) for specific frequency ωₖ, or integrate this transform over the chosen frequency interval Δωₖ.

$$f ( Δ {ω}_{k} , {z}_{i} , {θ}_{j} ) = {\int }_{Δ {ω}_{k}}^{ } d ω f ( ω , {z}_{i} , {θ}_{j} )$$

The eigenvectors for the filtered data are computed by applying a standard rotation algorithm suitable for non-orthogonal eigenvectors. For example but not limited to by Dellinger's modification of the Alford rotation (see, for example, Joe Dellinger, Bertram Nolte, and John Etgen, Symmetric Alford diagonalization, SEG Technical Program Expanded Abstracts, 1998, pp. 1673-1676).

The dependence of the eigenvectors on the frequency is obtained. For example, for fast and slow quasidipole eigenmodes f^{f}(Δωₖ,zᵢ,θ^{f}(Δωₖ)) and f^{s}(Δωₖ,zᵢ,θ^{s}(Δωₖ)).

Based on the results, the correct dispersion curves of the borehole modes can be generated. For example, by applying matrix pencil algorithm to data rotated with frequency dependent angles.

The matrix pencil algorithm (Estimating slowness dispersion from arrays of sonic logging waveforms S. W. Lang, A. L. Kurkjian, J. H. McClellan, C. F. Morris, T. W. Parks GEOPHYSICS April 1987, Vol. 52, No. 4, pp. 530-544) estimates the dispersion curves of the waves composing the signal. Typical procedure, employed currently in the industry, is to take acoustic logging waveforms, rotate by the angle determined by Alford rotation algorithm and to process rotated data by matrix pencil algorithm. Thus, possible frequency dependence of the rotation angles and possible non-orthogonality is not taken into account at present.

It is proposed to determine proper rotation angles (possibly non-orthogonal) from the dependence of the eigenvectors on the frequency obtained during previous step. For example, let αₖ and βₖ be the rotation angles for the k-th frequency range. Then the original data f(t,zᵢ,θⱼ) are rotated by these angles using Dellinger's modification of the Alford rotation. The resulting data are then filtered in the frequency interval Δωₖ (for example, using band pass filter). The data rotated and filtered in such a way are then processed with the usual matrix pencil algorithm. Thus, the part of the dispersion curves for the modes composing the signal is obtained in the frequency interval Δωₖ. Repeating this procedure for all frequency intervals of interest, one will obtain the dispersion curves in these intervals with the proper account for possible non-orthogonality of the modes and frequency dependence of their polarization.

The described procedure can be used to solve the inverse problem and estimate formation parameters, dispersion curve, etc. It can be done by comparing the modeled solution with the measured one. Example of this approach is as follows. Use low frequency band pass filtered and time windowed data to obtain low frequency asymptote of the flexural dispersion curves and to determine Vₚ, Vₛ and low-frequency asymptote of the flexural mode orientation by applying Dellinger's modification of the Alford rotation, which is able to account for geometrically non-orthogonal modes.

The estimated parameters can be used to model the eigenvectors (for example but not limited to SAFE, spectral method, Riccati equation, etc.).

The described procedure can be used to iterate inverse problem solver when finding formation parameters by comparing the reference solution with the measured one. It can be done by comparing the modeled solution with the measured one. Example of this approach is as follows. Use low frequency bandpass filtered and time windowed data to obtain low frequency asymptote of the flexural dispersion curves and to determine Vₚ, Vₛ and low-frequency asymptote of the flexural mode orientation by applying Dellinger's modification of the Alford rotation, which is able to account for geometrically non-orthogonal modes. Use the obtained result as the constraint to make the initial guess of the elastic moduli. Model the dispersion curves and eigenvectors using standard algorithms (spectral method, SAFE, etc.). Identify the discrepancy between measured dispersion curve and mode orientation and initial approximation in the full frequency range. Modify Thomsen parameters or elastic moduli tensor components in order to improve the match. Iterate. To determine parameters' change at each iteration, one can use various methods. For example, standard conjugate gradients, etc. As an example of possible application, the described procedure can be used to determine anisotropy or stress-induced anisotropy in boreholes with the complex shape of the cross section, for example oval.

The modeled or inverted dispersion curves can be to calculate/optimize survey parameters at wellsite or prior to the job. Idea is to optimize the excitation frequency band and amplitude based on the estimated dispersion curve. This could improve the data quality. In many cases it is not possible to receive actual well conditions/formation parameters until the last minute. By using these quick computation algorithms at wellsite there can be opportunities to optimize the Tx function. Potentially this can be used for repeat tool runs, also.

Data analysis or inversion algorithms can be used for estimation of contamination factors in complex borehole environments and vice versa evaluation of borehole parameters from contamination information. For example, when tool is eccentered tool in TTI anisotropy, ovalized boreholes in anisotropic formations, stress-induced anisotropy in anisotropic formations, etc.

An example of one of the embodiments relates to dispersion curve calculation and anisotropy direction determination using frequency dependent rotation of the data. Consider the 20-cm-major by 10-cm-minor radii elliptical borehole in anisotropic TTI formation, where anisotropy axes are not aligned with those of the borehole cross section. The material properties of subterranean formation corresponds to Austin Chalk with 2200 kg/m³ density, C₁₁=22 GPa, C₁₂=15.8 GPa, C₁₃=12 GPa, C₃₃=14 GPa, C₄₄=2.4 GPa. The TI symmetry axis inclined at 60° with respect to the vertical axis of borehole and rotated by 45° counterclockwise to the major axis of ellipse. The borehole is filled with fluid (1000 kg/m³ density, 1500 km/h sound speed).

Acoustic signals emitted by cross-dipole logging tool disposed in a borehole were simulated with high-order 3D numerical method. Two dipole sources of logging tool were directed at 60° and 150° with respect to the major axis of ellipse. Sound wave is generated by first derivative of Blackman-Harris pulse with central frequency of 4 kHz.

An array of receivers located in the logging tool detect pressure field signal in time domain. The receivers are spatially distributed along the tool body with spacing of 0.0925 m. The recorded signals form 4-component data vector according to conventional cross-dipole measurement technique.

The time domain representations of the detected acoustic signals were processed by orthogonal Alford rotation algorithm and its non-orthogonal modification. The obtained angles corresponds to eigenvectors orientation with respect to TI symmetry axis (positive values indicating counterclockwise rotation from the axis):
orthogonal Alford rotation: 35° and −55°;
non-orthogonal Alford rotation: 35° and −71°, 16° non-orthogonality of eigenvectors.

The time domain representations of the detected acoustic signals were converted into frequency domain. The main energy of acoustic signal was concentrated in frequency range from 2 kHz to 8 kHz. According to the claim, this range was split into three parts: low frequency (2-4 kHz), medium frequency (4-6 kHz) and high frequency (6-8 kHz) ranges.

For each selected range FIR filter was constructed and applied to initial time-domain representation of detected signals. Each time domain representation of filtered signal was processed by orthogonal and non-orthogonal Alford rotation algorithm. The following results for eigenvectors orientation took were obtained:
Low frequency range:
orthogonal: 14° and −76°,
non-orthogonal: 23° and −87° (20° non-orthogonality)
Medium frequency range:
orthogonal: 22° and −68°
non-orthogonal: 25° and −74° (9° non-orthogonality)
High frequency range:
orthogonal: 43° and −47°,
non-orthogonal: 44° and −50° (4° non-orthogonality)

These results confirm the dependence of the polarization direction of the wave on frequency. The approach considered in presented invention is able to determine frequency dependence of these directions. Conventional orthogonal Alford rotation processing is ineffective in considered case.

Suggested method can be used for a number of applications, raising them to the new technology level. Such applications include, but are not limited to:
Determination of elastic moduli. For instance, 5 TTI parameters. It is necessary for geomechanical applications like well stability, etc.
check of and comparison with dispersion curve analysis results. This is because the dispersion analysis may depend on the orientation of the modes.
interpretation. For example, to identify local variations of elastic parameters on known background.
development of wells. E.g. horizontal wells, gas shale wells, etc. For example, local variations of elastic moduli can be used to plan and improve completion decisions, geomechanical decisions, fracturing jobs design.

1. A computer-implemented method for processing acoustic signals comprising:
sending acoustic signals by a logging tool disposed in a borehole traversing a subterranean formation,
detecting the acoustic signals as they traverse the subterranean formation by receivers located on the logging tool,
creating time domain representations of the detected acoustic signals,
converting the time domain representations of the detected acoustic signals into frequency domain representations,
selecting at least one frequency range,
filtering the detected acoustic signals corresponding to each selected frequency range,
computing eigenvectors for the filtered data for each selected frequency range, and
obtaining dependence of the eigenvectors on the frequency.

2. The method of claim 1 wherein the time domain representations of the acoustic signals are converted into the frequency domain representations by Fourier transforming.

3. The method of claim 1 wherein the time domain representations of the acoustic signals are converted into the frequency domain representations by frequency filtering.

4. The method of claim 1 wherein the time domain representations of the acoustic signals are converted into the frequency domain representations by wavelet transforming.

5. The method of claim 1 wherein the detected acoustic signals corresponding to each frequency range are filtered by Fourier transforming.

6. The method of claim 1 wherein the detected acoustic signals corresponding to each frequency range are filtered by frequency filtering.

7. The method of claim 1 wherein the detected acoustic signals corresponding to each frequency range are filtered by wavelet transforming.

8. The method of claim 1 wherein the eigenvectors for the filtered data are computed by applying a standard rotation algorithm suitable for non-orthogonal eigenvectors.

9. The method of claim 1 additionally comprising obtaining frequency dependent dispersion curves.

10. The method of claim 9 wherein rotation angles for at least one frequency range are determined from the computed dependence of the eigenvectors on the frequency, the detected acoustic signals are rotated by the estimated rotation angles using non-orthogonal modification of the Alford rotation, the rotated signals are processed with a matrix pencil algorithm and the dispersion curves for the at least one frequency range are obtained.

11. The method of claim 10 wherein the rotated signals before processing are filtered.

12. The method of claim 11 wherein the rotated signals are filtered using band pass filter.

13. The method of claim 1 additionally comprising estimating formation parameters.

14. System for processing acoustic signals comprising:
a logging tool for sending acoustic signals in a borehole traversing a subterranean formation,
receivers located on the logging tool for detecting the acoustic signals as they traverse the subterranean formation,
a computer in communication with the logging tool, and
a set of instructions executable by the computer that, when executed by the computer cause the computer to:
create time domain representations of the detected acoustic signals,
convert the time domain representations of the detected acoustic signals into frequency domain representations,
select at least one frequency range,
filter the detected acoustic signals corresponding to each selected frequency range, and
compute eigenvectors for the filtered data for each selected frequency range and obtain dependence of the eigenvectors on the frequency.
